(19) United States
(12) Patent Application Publication
(10) Pub. No.: US 2013/0076498 A1
(43) Pub. Date: Mar. 28, 2013

(54) DISPLAY DEVICE

(71) Applicants: Manfred Suess, Remchingen (DE); Nicolas Mehl, Illkirchen-Graffensatden (FR); Isabel Hoffmann, Walzbachtal (DE); Bernd Ludewig, Weinheim (DE)

(72) Inventors: Manfred Suess, Remchingen (DE); Nicolas Mehl, Illkirchen-Graffensatden (FR); Isabel Hoffmann, Walzbachtal (DE); Bernd Ludewig, Weinheim (DE)

(73) Assignee: Johnson Control Technology Company, Holland, MI (US)

(21) Appl. No.: 13/257,201

(22) PCT Filed: Feb. 18, 2010
(86) PCT No.: PCT/EP10/01025

§ 371 Date: Feb. 6, 2012

(30) Foreign Application Priority Data
Mar. 20, 2009 (DE) 10 2009 014 167.7
Oct. 15, 2009 (DE) 10 2009 049 632.7

(51) Int. Cl. B60K 35/00

(52) U.S. Cl. CPC B60K 35/00
USPC 340/438

(57) ABSTRACT

A display device for a motor vehicle is proposed, wherein the display device has a first display area and a second display area, wherein the first display area is provided by way of a first display in the central area of a dial, wherein the second display area is designed so as to display a display information in an electroless manner.

### BACKGROUND

The invention relates to a display instrument, particularly for use in the automobile sector.

Motor vehicle display instruments are known in numerous design variants. It is, furthermore, known to incorporate electronic ink (sometimes denoted as “e-ink”) in a film for integration in electronic displays. The main constituents of electronic ink consist in numerous tiny microcapsules.

In accordance with one product variant of electronic ink, each microcapsule contains positively charged white particles and negatively charged black particles which are suspended in a clear liquid. Under the influence of an electric field, the white particles migrate to a first polarized area of the respective microcapsule, where they become visible to a viewer, and so the surface of the microcapsule appears as a white spot in the first polarized area. At the same time, under the influence of an opposite electric field black particles migrate to second polarized area, opposite first polarized area, where they are concealed. By a reversal of the electric field of the previously described process, the black particles appear in the first polarized area, the effect being that the surface of the microcapsule appears dark in the first polarized area.

In order to produce an electronic e-ink display, the electronic ink is printed onto a plastic film sheet which is laminated on a circuit layer. The circuit forms a pattern of pixels that is controlled by a display driver. The previously described microcapsules are suspended in a liquid carrier medium and can be printed with the use of known printing methods onto virtually all conceivable surfaces such as, for example, onto surfaces made from glass, fabric, paper or plastic.

### SUMMARY

An object of the invention is to provide a motor vehicle display device or a display device which renders it possible in a simple way and with as little power consumption as possible to display as great a variety of information as possible and, moreover, to do so in a simple and robust way.

The object is achieved by a display device for a motor vehicle, the display device having a first display area and a second display area, the first display area being provided by means of a first display in the central area of a dial, and the second display area is designed for the de-energized display of an item of display information.

An essential aspect of the invention consists in that a display instrument is formed at least partially from electronic paper (denoted as “e-paper” for short). It is therefore preferably provided that a second display with electronic ink is provided in the second display area. It is thereby easily possible to operate the second display with a high contrast and, at the same time, with a low energy consumption.

It is preferred according to the invention that the first display is provided in a first main plane of extent, that the second display is provided in a second main plane of extent, and that the second main plane of extent is arranged closer to the viewer of the display device than the first main plane of extent. Consequently, it is possible in accordance with the invention for the first and second display areas to be arranged in different planes in a simple and cost-effective way, and yet not to provide any mechanically complicated measures such as, for example, the drilling of a centrally arranged display (first display).

Furthermore, it is also preferred in accordance with the invention that the second display is designed in a fashion embracing the first display at least partially along a periphery of the dial. Owing to such an at least partial embracing or enclosing of the first display area by the second display area, it is possible according to the invention to fashion the entire display area of the display device and of the dial in an aesthetically pleasing way.

It is, furthermore, particularly preferred in accordance with the invention when the second display is provided for displaying a pointer. It is thereby possible to display information by pointer in a simple way and with a high contrast despite low energy consumption.

### DRAWINGS

An embodiment of the invention that is to be understood as purely exemplary is described below with reference to the single attached drawing.

FIG. 1 is a schematic plan view of an inventively configured motor vehicle display instrument or an inventive display device.

FIG. 2 is a schematic lateral illustration intended to explain different main planes of extent of the components of the display device.

### DETAILED DESCRIPTION

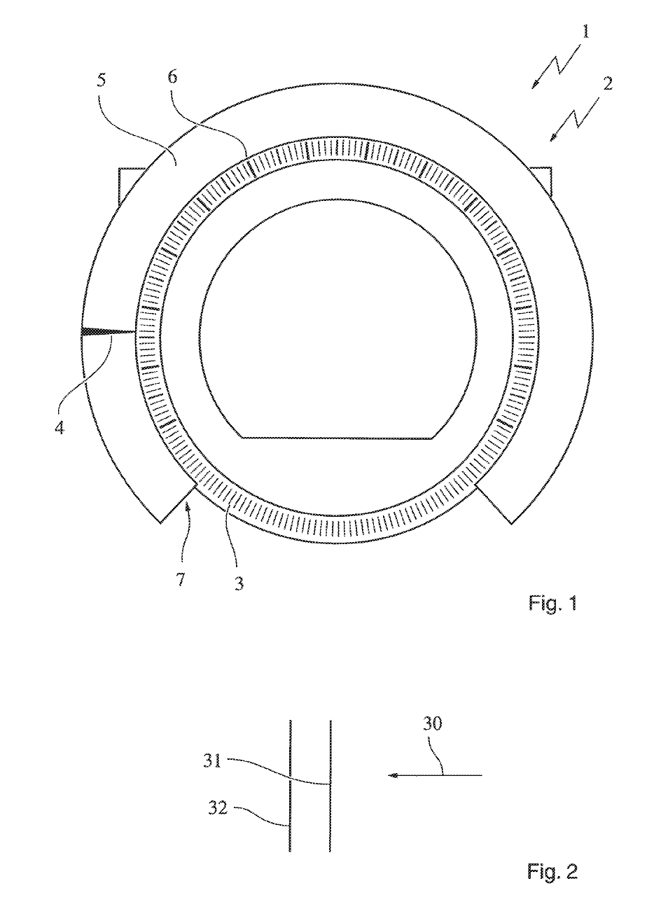

FIG. 1 is a schematic plan view of an inventive display device 1. The display device 1 preferably operates in analog fashion, or is at least reminiscent of an analog approach to the effect that essential parts are provided in the manner of an analog pointer arrangement. In the example, the display device 1 has a round dial 2. The dial 2 has a center and, outside the center (or lying radially outside or on the edge side), the dial has a scale 3 for the measured variable to be displayed (for example, the vehicle speed). Furthermore, the display device 1 has a pointer 4 that points to an appropriate point of the scale 3 as a function of the current value of the measured variable.

The pointer 4 extends, for example, in a radial direction and in a fashion tapering inward from a peripheral edge 5 in the form of a circumcircle bounding the display area of the display instrument 1 to a circumcircle 6 bounding the scale 3 radially outward.

The display device 1 has a first display area 11 inside the scale 3 (or in the direction to the central area of the display device 1). A first display 21 for displaying information is provided in the first display area 11. The first display 21 has a first main plane of extent 31, which is illustrated in FIG. 2 schematically (in a lateral illustration).

The display device 1 has a second display area 12 outside the first display area 11 or outside the scale 3 (that is to say in a fashion generally radially outside with reference to the central area of the display device 1). A second display 22 for displaying information is provided in the second display area 12. The second display 22 has a second main plane of extent 32 which is likewise illustrated schematically in FIG. 2 (in a lateral illustration). The second main plane of extent 32 is provided here in a fashion displaced by comparison with the first main plane of extent in the direction of a viewer or with reference to the viewing direction 30 of the display device 1.

According to the invention, the pointer 4 or the information of the second display area 12 or the second display 22 is displayed on a flat e-paper display device 7 which is arranged above the dial 2 and the display, that is to say on the side of the dial 2 facing the viewer.

Reference may be made to the statements made above under the section “Prior art” with regard to the basic technical knowledge relating to e-paper display devices.

The pointer 4 or the information displayed on the second display area 12 or the second display 22 remains visible even without electric current, that is to say can be regarded as static in a certain sense.

The pointer 4 appears, for example, in black on a white background, or in white on a black background. A different coloring can also be implemented given appropriate configuration of the second display area 12.

### LIST OF REFERENCE SYMBOLS

1 Display device/motor vehicle display instrument

2 Dial

2 Scale

4 Pointer

5 Peripheral edge

6 Circumcircle

7 E-paper display device

11 First display area

12 Second display area

21 First display

22 Second display

30 Viewing direction

31 First main plane of extent

32 Second main plane of extent

1. A display device for a motor vehicle, comprising a first display area and a second display area, the first display area comprising a first display in the central area of a dial, the second display area being configured for de-energized display of an item of display information.

2. The display device as claimed in claim 1, wherein a second display with electronic ink is provided in the second display area.

3. The display device as claimed in claim 2, wherein, the first display is provided in a first main plane of extent, and wherein the second display is provided in a second main plane of extent, and wherein the second main plane of extent is arranged closer to the viewer of the display device than the first main plane of extent (31).

4. The display device as claimed in claim 2, wherein, the second display embraces the first display at least partially along a periphery of the dial.

5. The display device as claimed in claim 2, wherein, the second display is provided for displaying a pointer.
